(19) United States
(12) Patent Application Publication
(10) Pub. No.: US 2019/0284514 A1
(43) Pub. Date: Sep. 19, 2019

(54) WATER-SOLUBLE UNIT DOSE ARTICLE COMPRISING ZWITTERIONIC POLYAMINE

(71) Applicant: The Procter & Gamble Company, Cincinnati, OH (US)

(72) Inventors: Colin URE, Tyne & Wear (GB); Alan Thomas BROOKER, Newcastle upon Tyne (GB); Nigel Patrick SOMERVILLE ROBERTS, Newcastle upon Tyne (GB); Robby Renilde Francois KEULEERS, Lippelo (BE)

(21) Appl. No.: 16/432,963

(22) Filed: Jun. 6, 2019

Related U.S. Application Data
(63) Continuation of application No. PCT/US2017/065674, filed on Dec. 12, 2017.

(30) Foreign Application Priority Data
Dec. 28, 2016 (EP) 16207069.2

(51) Int. Cl. C11D 17/04; C11D 3/43; C11D 1/94

(52) U.S. Cl. CPC C11D 17/045; C11D 11/0017; C11D 1/94; C11D 3/43

(57) ABSTRACT

The present disclosure is to a water-soluble unit dose article comprising a laundry detergent composition wherein the detergent contains a zwitterionic polyamine, and methods of using said unit dose article.

### FIELD OF THE INVENTION

The present invention is to a water-soluble unit dose article comprising a laundry detergent composition wherein the detergent comprises a zwitterionic polyamine, and methods of using said unit dose article.

### BACKGROUND OF THE INVENTION

Water-soluble unit dose articles are liked by consumers due to their convenience and ease of use during the laundry operation.

Such water-soluble unit dose articles often comprise laundry detergent compositions. Formulators prefer to formulate alkyl sulphates or alkoxylated alkyl sulphates into laundry detergent compositions to provide cleaning benefits. Alkyl sulphates and alkoxylated alkyl sulphates exhibit improved water hardness tolerance as compared to other anionic surfactant such as linear alkylbenzene sulphonate. This results in better whiteness as well as robust cleaning and sudsing performance across wash conditions. In addition alkyl sulphates and alkoxylated alkyl sulphates show excellent cleaning performance on hydrophilic stains such as grass stains, especially under diluted conditions such as so called ‘top loader’ washing machines. Often, ethoxylated polyethyleneimines are also formulated to provide particulate soil removal.

However, there is a need for water-soluble unit dose articles comprising liquid detergent compositions comprising alkyl sulphates/alkoxylated alkyl sulphates to provide improved particulate soil removal from fabrics during the wash.

It was surprisingly found that a water-soluble unit dose article comprising a laundry detergent composition comprising an alkyl sulphate/alkoxylated alkyl sulphate and a zwitterionic polyamine overcame this technical problem.

### SUMMARY OF THE INVENTION

A first aspect of the present invention is a water-soluble unit dose article comprising a water-soluble film and a laundry detergent composition, wherein the laundry detergent composition is preferably selected from a liquid, a solid or a mixture thereof, and wherein said detergent composition comprises;
a. a zwitterionic polyamine, preferably between 0.01% to about 20%, preferably from 0.1% to 10%, more preferably from 0.5% to 7%, even more preferably from 1% to 5%, most preferably from 2% to 4% by weight of the laundry detergent composition of the zwitterionic polyamine; and
b. a first non-soap anionic surfactant selected from an alkyl sulphate anionic surfactant, an alkoxylated alkyl sulphate anionic surfactant or a mixture thereof.

A second aspect of the present invention is a process for washing fabrics comprising the steps of;
a. Combining a water-soluble unit dose article according to the present invention with sufficient water to dissolve the water-soluble film and dilute the laundry detergent composition by a factor of between 300 and 800 fold to form a wash liquor;
b. Combining the wash liquor with at least one fabric to be washed.

### BRIEF DESCRIPTION OF THE DRAWINGS

FIG. 1 is a water-soluble unit dose article according to the present invention.

### DETAILED DESCRIPTION OF THE INVENTION

### Water-Soluble Unit Dose Article

The present invention discloses a water-soluble unit dose article comprising a water-soluble film and a laundry detergent composition. The laundry detergent composition is described in more detail below. The water-soluble film is described in more detail below.

The water-soluble unit dose article comprises the water-soluble film shaped such that the unit-dose article comprises at least one internal compartment surrounded by the water-soluble film. The unit dose article may comprise a first water-soluble film and a second water-soluble film sealed to one another such to define the internal compartment. The water-soluble unit dose article is constructed such that the detergent composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the detergent composition. During manufacture, a first water-soluble film may be shaped to comprise an open compartment into which the detergent composition is added. A second water-soluble film is then laid over the first film in such an orientation as to close the opening of the compartment. The first and second films are then sealed together along a seal region.

The unit dose article may comprise more than one compartment, even at least two compartments, or even at least three compartments. The compartments may be arranged in superposed orientation, i.e. one positioned on top of the other. In such an orientation the unit dose article will comprise three films, top, middle and bottom. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

In a multi-compartment orientation, the detergent composition according to the present invention may be comprised in at least one of the compartments. It may for example be comprised in just one compartment, or may be comprised in two compartments, or even in three compartments.

Each compartment may comprise the same or different compositions. The different compositions could all be in the same form, or they may be in different forms.

The water-soluble unit dose article may comprise at least two internal compartments, wherein the laundry detergent composition is comprised in at least one of the compartments, preferably wherein the unit dose article comprises at least three compartments, wherein the detergent composition is comprised in at least one of the compartments.

The water-soluble unit dose article may comprise at least two compartments, preferably at least three compartments, wherein the laundry detergent composition is comprised within at least one compartment. The laundry detergent composition may represent a culmination of ingredients located within all the compartments of the unit dose article.

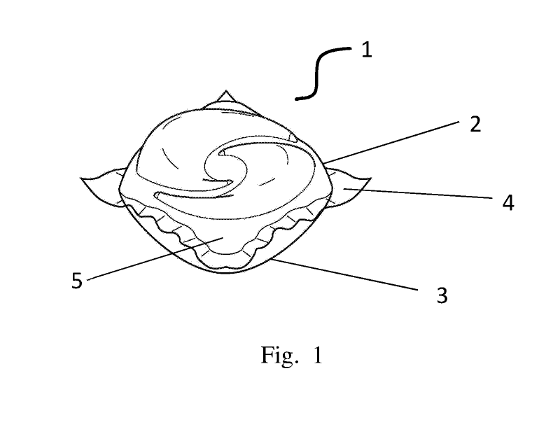

FIG. 1 discloses a water-soluble unit dose article (1) according to the present invention. The water-soluble unit dose article (1) comprises a first water-soluble film (2) and a second water-soluble film (3) which are sealed together at a seal region (4). The laundry detergent composition (5) is comprised within the water-soluble soluble unit dose article (1).

### Laundry Detergent Composition

The water-soluble unit dose article comprises a laundry detergent composition. The laundry detergent composition, may be a liquid, a solid or a mixture thereof.

The term ‘solid laundry detergent composition’ refers to any laundry detergent composition that is solid. Solid can include, particles, compressed solids or a mixture thereof.

The term ‘liquid laundry detergent composition’ refers to any laundry detergent composition comprising a liquid capable of wetting and treating a fabric, and includes, but is not limited to, liquids, gels, pastes, dispersions and the like. The liquid composition can include solids or gases in suitably subdivided form, but the liquid composition excludes forms which are non-fluid overall, such as tablets or granules.

The liquid detergent composition can be used in a fabric hand wash operation or may be used in an automatic machine fabric wash operation.

The laundry detergent composition comprises a zwitterionic polyamine. The zwitterionic polyamine is described in more detail below.

The water-soluble unit dose article may comprise between 0.01% to about 20%, preferably from 0.1% to 10%, more preferably from 0.5% to 7%, even more preferably from 1% to 5%, most preferably from 2% to 4% by weight of the laundry detergent composition of the zwitterionic polyamine.

The laundry detergent composition comprises a first non-soap anionic surfactant selected from an alkyl sulphate anionic surfactant, an alkoxylated alkyl sulphate anionic surfactant or a mixture thereof.

Preferably, the laundry detergent composition comprises between 2% and 30%, preferably between 5% and 25%, more preferably between 7% and 20%, most preferably between 10% and 17% by weight of the laundry detergent composition of the first non-soap surfactant.

The first non-soap surfactant is preferably a C10-18 alkyl sulphate, a C10-18 alkoxylated alkyl sulphate or a mixture thereof.

Preferably, the first non-soap surfactant is an alkoxylated alkyl sulphate, preferably an ethoxylated alkyl sulphate with an average degree of ethoxylation of between 0.5 and 7, preferably between 1 and 5, more preferably between 2 and 4, most preferably about 3, or wherein the first non-soap surfactant is a mixture of one or more alkoxylated alkyl sulphates, preferably ethoxylated alkyl sulphates, and optionally an alkyl sulphate, the mixture having an average degree of ethoxylation of between 0.5 and 7, preferably between 1 and 5, more preferably between 2 and 4, most preferably about 3.

The laundry detergent composition may comprise a second non-soap anionic surfactant, wherein the second non-soap anionic surfactant is selected from linear alkylbenzene sulphonate. Preferably, the laundry detergent composition comprises between 2% and 30%, preferably between 5% and 27%, more preferably between 7% and 25%, most preferably between 10% and 23% or even between 10% and 17% by weight of the laundry detergent composition of the second non-soap surfactant.

The laundry detergent composition may comprise between 0% and 10% preferably between 0.01% and 8%, more preferably between 0.1% and 6%, most preferably between 0.15% and 4% by weight of the laundry detergent composition of a non-ionic surfactant. Preferably, the non-ionic surfactant is selected from alcohol alkoxylate, an oxo-synthesised alcohol alkoxylate, Guerbet alcohol alkoxylates, alkyl phenol alcohol alkoxylates or a mixture thereof.

Suitable alcohol ethoxylate nonionic surfactants include the condensation products of aliphatic alcohols with from 1 to 25 moles of ethylene oxide. The alkyl chain of the aliphatic alcohol can either be straight or branched, guerbet, primary or secondary, and generally contains from 8 to 22 carbon atoms. The starting alcohol can be naturally derived, e.g. starting from natural oils, or synthetically derived, e.g. alcohols obtained from for example oxo-, modified oxo- or Fischer-Tropsch processes. Examples of oxo-process derived alcohols include the Lial and Isalchem alcohols ex Sasol company and Lutensol alcohols ex BASF company. Examples of modified-oxo process derived alcohols include the Neodol alcohols ex Shell company. Fischer-Tropsch derived alcohols include Safol alcohols ex Sasol company. The alkoxylate chain of alcohol ethoxylates is made up solely of ethoxylate groups.

Preferably, the alcohol ethoxylate non-ionic surfactant comprises on average between 8 and 18, more preferably between 10 and 16 even more preferably between 12 and 15 carbon atoms in the alcohol carbon chain, and on average between 5 and 12, preferably between 6 and 10, more preferably between 7 and 8 ethoxy units in the ethoxylation chain.

Preferably, the weight ratio of alkoxylated alkyl sulphate to linear alkylbenzene sulphonate is from 2:1 to 1:8 preferably from 1:1 to 1:5 most preferably from 1:1.25 to 1:4.

Preferably, the weight ratio of non-soap anionic surfactant to non-ionic surfactant is from 1:1 to 40:1, preferably from 1:1 to 20:1, more preferably from 1.3:1 to 15:1, even more preferably from 1.5:1 to 10:1.

Preferably, the laundry detergent composition comprises between 10% and 60%, preferably between 12% and 50%, most preferably between 15% and 40% by weight of the laundry detergent composition of a non-aqueous solvent. Preferably, the non-aqueous solvent is selected from 1,2-Propanediol, glycerol, sorbitol, dipropylene glycol, tripropyleneglycol, polypropylene glycol or a mixture thereof.

Preferably, the water-soluble unit dose article comprises 15% or less by weight of the unit dose article of water, preferably the unit dose article comprises between 0.1% and 15%, more preferably between 1% and 12.5% by weight of the unit dose article of water.

The laundry detergent composition may comprise a polymer selected from amphiphilic graft copolymers, carboxymethyl cellulose, modified carboxymethylcellulose, polyester terephthalate polymers, hydroxyethylcellulose, modified hydroxyethylcellulose or a mixture thereof. Especially preferred are cationic modified hydroxyethylcellulose. Preferably, the laundry detergent composition comprises between 0.5% and 10%, preferably between 0.75% and 7%, more preferably between 1.5% and 5% by weight of the laundry detergent composition of the second polymer.

The laundry detergent composition may comprise between 0% and 10%, preferably between 0.1% and 7%, more preferably between 0.2% and 5% by weight of the laundry detergent composition of a fatty acid, a neutralised fatty acid soap or a mixture thereof.

Preferably, the water-soluble unit dose article comprises less than 3%, preferably less than 2% by weight of the laundry detergent composition of ethoxylated polyethyleneimine. The laundry detergent composition may comprise essentially no ethoxylated polyethyleneimine. Alternatively, the laundry detergent composition may comprise low levels of an ethoxylated polyethyleneimine. The laundry detergent composition may comprise between 0.01% and 3%, preferably between 0.01% and 2% by weight of the laundry detergent composition of an ethoxylated polyethyleneimine

### Zwitterionic Polyamine

The laundry detergent composition comprises a zwitterionic polyamine. Preferably, the zwitterionic polyamine is selected from zwitterionic polyamines having the following formula:

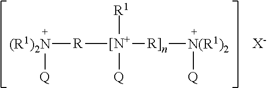

R is C3-C20 preferably C5-C10 more preferably C6-C8 linear or branched alkylene, and mixtures thereof, most preferably linear C6.

R¹ is an anionic or partially anionic unit-capped polyalkyleneoxy unit having the formula: —(R2O)xR3, wherein R2 is C2-C4 linear or branched alkylene, and mixtures thereof, preferably C2 or branched C3 and mixtures thereof, more preferably C2 (ethylene); R3 is hydrogen, an anionic unit, and mixtures thereof, in which not all R3 groups are hydrogen; x is from about 5 to about 50, preferably from about 10 to about 40, even more preferably from about 15 to about 30, most preferably from about 20 to about 25. A preferred value for x is 24, especially when R′ comprises entirely ethyleneoxy units. Depending upon the method by which the formulator chooses to form the alkyleneoxy units, the wider or narrower the range of alkyleneoxy units present. The formulator will recognize that when ethoxylating a zwitterionic polyamine, only an average number or statistical distribution of alkyleneoxy units will be know. x values highlighted represent average values per polyalkoxy chain. Preferably the range of alkyleneoxy units within the zwitterionic polyamine is plus or minus two units, more preferably plus or minus one unit. Most preferably each R′ group comprises about the same average number of alkyleneoxy units. Non-limiting examples of R3 anionic units include —(CH2)pCO2M; —(CH2)qSO3M; —(CH2)qOSO3M; —(CH2)qCH(SO2M)-CH2SO3M; —(CH2)qCH(OSO2M)CH2OSO3M; —(CH2)qCH(SO3M)CH2SO3M; —(CH2)pP03M; —P03M; —S03M and mixtures thereof; wherein M is hydrogen or a water soluble cation in sufficient amount to satisfy charge balance. Preferred anionic units are —(CH2)pC02M; —S03M, more preferably —S03M (sulfonate group). The indices p and q are integers from 0 to 6, preferably 0 to 2, most preferably 0. For the purposes of the present invention, all M units, can either be a hydrogen atom or a cation depending upon the form isolated by the artisan or the relative pH of the system wherein the compound is used. Non-limiting examples of preferred cations include sodium, potassium, ammonium, and mixtures thereof.

Q is a quaternizing unit selected from the group consisting of C1-C30 linear or branched alkyl, C6-C30 cycloalkyl, C7-C30 substituted or unsubstituted alkylenearyl, and mixtures thereof, preferably C1-C30 linear or branched alkyl, even more preferably C1-C10 or even C1-C5 linear or branched alkyl, most preferably methyl; the degree of quaternization preferably is more than 50%, more preferably more than 70%, even more preferably more than 90%, most preferably about 100%.

X is an anion present in sufficient amount to provide electronic neutrality, preferably a water soluble anion selected from the group consisting of chlorine, bromine, iodine, methylsulfate, and mixtures thereof, more preferably chloride. To a great degree, the counter ion X will be derived from the unit which is used to perform the quaternization. For example, if methyl chloride is used as the quaternizing agent, chlorine (chloride ion) will be the counter ion X. Bromine (bromide ion) will be the dominant counter ion in the case where benzyl bromide is the quaternizing reagent.

n is from 0 to 4, preferably 0 to 2, most preferably 0.

Preferably from about 10% to about 100%, more preferably from about 20% to about 70%, even more preferably from 30% to about 50%, most preferably from about 35% to about 45% of the R3 groups are an anionic unit, preferably a sulfonate unit, the remaining R3 units being hydrogen.

Particularly preferred zwitterionic polyamines are zwitterionic hexamethylene diamines according to the following formula:

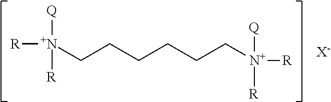

R is an anionic or partially anionic unit-capped polyalkyleneoxy unit having the formula: —(R20)xR3 wherein R2 is C2-C4 linear or branched alkylene, and mixtures thereof, preferably C2 or branched C3 and mixtures thereof, even more preferably C2 (ethylene); R3 is hydrogen, an anionic unit, and mixtures thereof, in which not all R3 groups are hydrogen; x is from about 5 to about 50, preferably from about 10 to about 40, even more preferably from about 15 to about 30, most preferably from about 20 to about 25. A preferred value for x is 24, especially when R comprises entirely ethyleneoxy units. Depending upon the method by which the formulator chooses to form the alkyleneoxy units, the wider or narrower the range of alkyleneoxy units present. The formulator will recognize that when ethoxylating a zwitterionic polyamine, only an average number or statistical distribution of alkyleneoxy units will be know. x values highlighted represent average values per polyalkoxy chain. Preferably the range of alkyleneoxy units within the zwitterionic polyamine is plus or minus two units, more preferably plus or minus one unit. Most preferably each R group comprises about the same average number of alkyleneoxy units. Non-limiting examples of R3 anionic units include —(CH2)pCO2M; —(CH2)qSO3M; —(CH2)qOS03M; —(CH2)qCH(SO2M)-CH2SO3M; —(CH2)qCH(OS02M)CH2OSO3M; —(CH2)qCH(SO3M)CH2SO3M; —(CH2)pP03M; —P03M; —S03M and mixtures thereof; wherein M is hydrogen or a water soluble cation in sufficient amount to satisfy charge balance. Preferred anionic units are —(CH2)pC02M; —S03M, more preferably —S03M (sulfonate group). The indices p and q are integers from 0 to 6, preferably 0 to 2, most preferably 0. For the purposes of the present invention, all M units, can either be a hydrogen atom or a cation depending upon the form isolated by the artisan or the relative pH of the system wherein the compound is used. Non-limiting examples of preferred cations include sodium, potassium, ammonium, and mixtures thereof.

Q is a quaternizing unit selected from the group consisting of C1-C30 linear or branched alkyl, C6-C30 cycloalkyl, C7-C30 substituted or unsubstituted alkylenearyl, and mixtures thereof, preferably C1-C30 linear or branched alkyl, even more preferably C1-C10 or even C1-C5 linear or branched alkyl, most preferably methyl; the degree of quaternization preferably is more than 50%, more preferably more than 70%, even more preferably more than 90%, most preferably about 100%.

X is an anion present in sufficient amount to provide electronic neutrality, preferably a water soluble anion selected from the group consisting of chlorine, bromine, iodine, methylsulfate, and mixtures thereof, more preferably chloride. To a great degree, the counter ion X will be derived from the unit which is used to perform the quaternization. For example, if methyl chloride is used as the quaternizing agent, chlorine (chloride ion) will be the counter ion X. Bromine (bromide ion) will be the dominant counter ion in the case where benzyl bromide is the quaternizing reagent.

Preferably from about 10% to about 100%, more preferably from about 20% to about 70%, even more preferably from 30% to about 50%, most preferably from about 35% to about 45% of the R3 groups are an anionic unit, preferably a sulfonate unit, the remaining R3 units being hydrogen.

Most preferred compound is the zwitterionic hexamethylene diamine represented by the following formula:

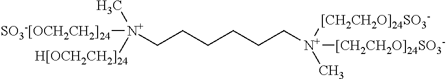

in which approximately 40% of the polyethoxy groups are sulfonated, the remaining polyethoxy groups being hydrogen capped. The degree of quaternization preferably is more than 90%, most preferably about 100%. Preferably the water soluble counter-anion is selected from the group consisting of chlorine, bromine, iodine, methylsulfate, and mixtures thereof, more preferably chloride.

The described zwitterionic polyamines can be made using techniques previously described in the art, and as such those skilled in the art would understand how to produce such compounds. The polyamine is first alkoxylated for example ethoxylated with ethylene oxide, followed by a quaternization step for example by reacting the alkoxylated polyamine with dimethylsulfate, and finally an anionic group substitution step for example by reacting the quaternized alkoxylated polyamine with chlorosulfonic acid.

### Water-Soluble Film

The film of the present invention is soluble or dispersible in water. The water-soluble film preferably has a thickness of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns:

5 grams±0.1 gram of film material is added in a pre-weighed 3 L beaker and 2 L±5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers and/or copolymers can also be used as the pouch material, especially mixtures of polyvinylalcohol polymers and/or copolymers, especially mixtures of polyvinylalcohol homopolymers and/or anionic polyvinylalcohol copolymers preferably selected from sulphonated and carboxylated anionic polyvinylalcohol copolymers especially carboxylated anionic polyvinylalcohol copolymers. Most preferably the water soluble film comprises a blend of a polyvinylalcohol homopolymer and a carboxylated anionic polyvinylalcohol copolymer.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310.

The film may be opaque, transparent or translucent. The film may comprise a printed area.

The area of print may be achieved using standard techniques, such as flexographic printing or inkjet printing.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 rpm.

### Process of Washing

A further aspect of the present invention is a process for washing fabrics comprising the steps of;
a. Combining a water-soluble unit dose article according to the present invention with sufficient water to dissolve the water-soluble film and dilute the laundry detergent composition by a factor of between 300 and 800 fold to form a wash liquor;
b. Combining the wash liquor with at least one fabric to be washed.

The wash process may be conducted in a hand wash operation, an automatic wash machine operation or a mixture thereof.

### Process of Making

Those skilled in the art will know how to make the unit dose article and laundry detergent composition of the present invention using known techniques in the art.

During manufacture, a first water-soluble film may be shaped to comprise an open compartment into which the detergent composition is added. A second water-soluble film is then laid over the first film in such an orientation as to close the opening of the compartment. The first and second films are then sealed together along a seal region using known sealing means such as solvent, heat or a mixture thereof.

### Examples

A particulate stain removal wash test was performed single variably comparing a water-soluble unit dose laundry formulation according to the invention comprising alkyl ethoxy sulphate anionic surfactant and a zwitterionic polyamine, with a comparative formula outside the scope of the invention comprising alkyl ethoxy sulphate anionic surfactant and an ethoxylated polyimine soil release polymer known to be effective on particulate stain removal.

### Particulate Stain Removal Wash Test:

A short cotton cycle at 40° C. and 9 gpg water hardness has been selected on a Miele washing machine (model 3622). Total run time was 90 minutes. 2.5 kg cotton ballast loads (sourced from Warwick Equest Ltd. Unit 55, Consett Business Park, Consett, County Durham, DH8 6BN) were added together with a soiled load (2 SBL2004 soiled ballast sheets ex wfk Testgewebe GmbH Christenfeld 10, D-41379 Brüggen-Bracht Germany order ref 10996) and together with stained cotton test fabrics (sourced from Warwick Equest Ltd. Unit 55, Consett Business Park, Consett, County Durham, DH8 6BN). Test products were added directly into the drum prior to starting the wash cycle. After washing ballast and soiled load and test fabrics were tumble dried in a Miele tumble dryer set to “extra dry”.

The stained cotton test fabrics were washed with one of the test products described below. The results were then analysed by image analysis which is a method that enables to calculate the amount of stain that is removed. Stains are imaged before washing and after washing. The imaging calculates the amount of stain removed, reflected as a stain removal index (SRI—% stain removed). SRI of 100 means complete removal and SRI of zero means no removal.

The Laundry Image Analysis system (Merlin image analysis system) measures stain removal on technical stain swatches. The system utilizes a video camera to acquire colour images of swatches. An image of the swatch is taken before and after it is washed. The acquired image is then analysed by computer software (Procter and Gamble Global R&D computing). The software compares the unwashed stain to the washed stain, as well as the unwashed fabric to the washed fabric. The result is expressed as a stain removal index.

Each stain was duplicated within each wash cycle (2 internal replicates). This test has been repeated 3 times for each test leg (3 external replicates) and the resulting 6 individual stain removal index results were averaged and reported.

### Formula Compositions:

The following water-soluble unit dose laundry compositions were prepared through mixing of the individual components. 18.5 g of Base product was added via a dosing ball in each wash test. Lutensol FP620 (ethoxylated polyimine polymer ex BASF—PEI600EO20) and Lutensit Z96 (zwitterionic polyamine ex BASF—zwitterionic hexamethylene diamine according to below formula: 100% quaternized and about 40% of the polyethoxy (EO24) groups are sulfonated) were added on top as 1% solutions in water adjusted to pH 7.5, prepared as described below. Fatty acid was directly added on top of the base product.

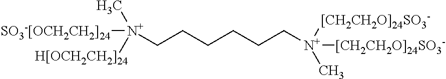

### Preparation of 1% Active Solutions:

Lutensol FP620: Weigh 12.69 g of 78.8% active Lutensol FP620 into a 600 ml beaker, add 400 ml deionised water and adjust the pH to 7.50 using a pH meter and 0.05N citric acid. Transfer the resulting solution to a 1000 ml flask and add deionized water till 1000 ml.
Lutensit Z96: Weigh 14.49 g of 69% active Lutensit Z96 into a 600 ml beaker, add 400 ml deionised water and adjust the pH to 7.50 using a pH meter and 0.05N citric acid. Transfer the resulting solution to a 1000 ml flask and add deionized water till 1000 ml.

### Base Product:

| | Base product |
|---|---|
| | wt % |
| Propylene 1,2-diol | 8.394 |
| Sodium Laureth Sulfate (68% in water) | 23.975 |
| Brightener 49 | 5.588 |
| Citric acid (50% in water) | 1.582 |
| DiPropyleneGlycol | 16.780 |
| Glycerin | 3.598 |
| Editronic Acid (66% in water) | 2.172 |
| Linear alkylbenzene sulphonic acid | 17.979 |
| Potassium Sulfite (45% in water) | 0.269 |
| Mannanase enzyme | 0.346 |
| Monoethanolamine | 6.622 |
| Nonionic Surfactant (C24EO7) | 1.199 |
| Polymer Sokalan PG101 | 5.109 |
| Perfume | 2.613 |
| Termamyl Ultra Amylase enzyme | 0.157 |
| Protease enzyme | 1.660 |
| Everest 200L Amylase enzyme | 0.157 |
| Water | 1.799 |

### Addition of Actives:

| | Comparative | | Comparative | |
|---|---|---|---|---|
| | example 1 | Example 1 | example 2 | Example 2 |
| Material | Base + Lutensol | Base + Lutensit | Base + Lutensol | Base + Lutensit |
| | FP620 nil FA | Z96 nil FA | FP620 with FA | Z96 with FA |
| | Gram per wash | Gram per wash | Gram per wash | Gram per wash |
| Lutensol | 0.6 (added as 60 ml | — | 0.6 (added as | — |
| FP620 | of 1% solution) | | 60 ml of 1% | |
| | | | solution) | |
| Lutensit Z96 | — | 0.6 (added as | — | 0.6 (added as |
| | | 60 ml of 1% | | 60 ml of 1% |
| | | solution) | | solution) |
| Topped Palm | — | — | 0.9 | 0.9 |
| Kernel Fatty | | | | |
| Acid (FA) | | | | |

### Test Results:

The particulate stain removal data summarized in table 1 and 2 below show the example compositions according to the invention comprising both the alkyl ethoxy sulphate anionic surfactant and the zwitterionic polyamine to be more effective in particulate soil removal than comparative example formulations outside the scope of the invention single variable differing in soil removal polymer chemistry. The effect has been shown within formulations not comprising a fatty acid (table 1) as well as for compositions comprising a fatty acid (table 2).

TABLE 1
% Particulate stain removal in nil fatty acid nonaqueous
laundry liquid formulation

| | | | | % |
|---|---|---|---|---|
| | | | | Improvement |
| | Comparative | | Difference in | in stain |
| Soil | Example 1 | Example 1 | stain removal | removal |
| Black todd clay | 56.4 | 61.1 | 4.7 | 8.3 |
| Brown silica | 15.0 | 22.8 | 7.8 | 52.0 |
| sand | | | | |
| Grass | 81.7 | 83.3 | 1.6 | 2.0 |
| Hoover dust | 53.1 | 59.4 | 6.3 | 11.9 |
| Humax Peat | 30.6 | 34.5 | 3.9 | 12.7 |
| NTC clay | 33.2 | 37.8 | 4.6 | 13.9 |
| Stanley clay | 36.1 | 40.6 | 4.5 | 12.5 |
| Average | 43.7 | 48.5 | 4.8 | 16.2 |

TABLE 2
% Particulate stain removal in fatty acid comprising nonaqueous
laundry liquid formulation

| | | | | % |
|---|---|---|---|---|
| | | | | Improvement |
| | Comparative | | Difference in | in stain |
| Soil | Example 2 | Example 2 | stain removal | removal |
| Black todd clay | 65.0 | 65.9 | 0.9 | 1.4 |
| Brown silica | 29.0 | 33.5 | 4.5 | 15.5 |
| sand | | | | |
| Grass | 86.6 | 86.7 | 0.1 | 0.1 |
| Hoover dust | 68.8 | 71.8 | 3.0 | 4.4 |
| Humax Peat | 45.0 | 47.5 | 2.5 | 5.6 |
| NTC clay | 46.3 | 49.8 | 3.5 | 7.6 |
| Stanley clay | 46.7 | 49.0 | 2.3 | 4.9 |
| Average | 55.3 | 57.7 | 2.4 | 5.6 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

What is claimed is:

1. A water-soluble unit dose article comprising a water-soluble film and a laundry detergent composition, wherein said laundry detergent composition comprises:
a. a zwitterionic polyamine; and
b. a first non-soap anionic surfactant selected from the group consisting of an alkyl sulphate anionic surfactant, an alkoxylated alkyl sulphate anionic surfactant, and a mixture thereof.

2. The water-soluble unit dose article according to claim 1, wherein said laundry detergent composition is selected from a liquid, a solid, or a mixture thereof.

3. The water-soluble unit dose article according to claim 1, wherein said laundry detergent composition comprises between 0.01% to about 20%, by weight of the laundry detergent composition, of the zwitterionic polyamine.

4. The water-soluble unit dose article according to claim 1, wherein said zwitterionic polyamine is selected from zwitterionic polyamines according to the following formula: 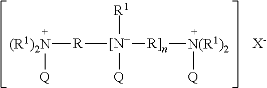
wherein:
R is C3-C20;
R¹ is an anionic unit-capped polyalkyleneoxy unit having the formula: —(R20)xR3, wherein R2 is C2-C4 linear or branched alkylene, and mixtures thereof; R3 is hydrogen, an anionic unit, and mixtures thereof, in which not all R3 groups are hydrogen; x is from 5 to 50;
Q is a quaternizing unit selected from the group consisting of C1-C30 linear or branched alkyl, C6-C30 cycloalkyl, C7-C30 substituted or unsubstituted alkylenearyl, and mixtures thereof; X is an anion present in sufficient amount to provide electronic neutrality;
n is from 0 to 4.

5. The water-soluble unit dose article according to claim 4 wherein said zwitterionic polyamine is selected from zwitterionic polyamines according to the following formula: 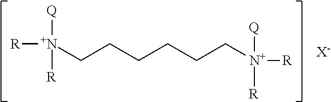
wherein
R is an anionic unit-capped polyalkyleneoxy unit having the formula:—(R2O)xR3 wherein R2 is C2-C4 linear or branched alkylene, and mixtures thereof;
R3 is hydrogen, an anionic unit, and mixtures thereof, in which not all R3 groups are hydrogen; x is from 5 to 50; Q is a quaternizing unit selected from the group consisting of C1-C30 linear or branched alkyl, C6-C30 cycloalkyl, C7-C30 substituted or unsubstituted alkylenearyl, and mixtures thereof; X is an anion present in sufficient amount to provide electronic neutrality.

6. The water-soluble unit dose article according to claim 5, wherein said R3 anionic units are selected from the group consisting of: —(CH2)pCO2M; —(CH2)qSO3M; —(CH2)qOS03M; —(CH2)qCH(SO2M)-CH2SO3M; —(CH2)qCH(OS02M)CH2OSO3M; —(CH2)qCH(SO3M)CH2SO3M; —(CH2)pP03M; —P03M;—SO3M; and mixtures thereof; wherein p and q are integers from 0 to 6; and wherein M is hydrogen or a water soluble cation in sufficient amount to satisfy charge balance.

7. The water-soluble unit dose article according to claim 5, wherein said zwitterionic polyamine is selected from zwitterionic polyamines according to the following formula; 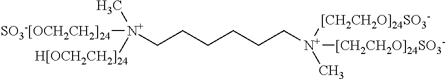
wherein from about 20% to about 70% of the polyethoxy groups are sulfonated, the remaining polyethoxy groups being hydrogen capped;
the degree of quaternization is more than 90%; and
the anion is selected from the group consisting of chlorine, bromine, iodine, methylsulfate, and mixtures thereof.

8. The water-soluble unit dose article according to claim 1, wherein the laundry detergent composition comprises between 2% and 30% by weight of the laundry detergent composition of the first non-soap surfactant.

9. The water-soluble unit dose article according to claim 1 wherein the first non-soap surfactant is a C10-18 alkyl sulphate, a C10-18 alkoxylated alkyl sulphate, or a mixture thereof.

10. The water-soluble unit dose article according to claim 1, wherein the first non-soap surfactant is an alkoxylated alkyl sulphate.

11. The water-soluble unit dose article according to claim 1, further comprising a second non-soap anionic surfactant, wherein the second non-soap anionic surfactant is linear alkylbenzene sulphonate.

12. The water-soluble unit dose article according to claim 1, further comprising between 0% and 10% by weight of the laundry detergent composition of a non-ionic surfactant.

13. The water-soluble unit dose article according to claim 1, further comprising between 10% and 45%, by weight of the laundry detergent composition of a non-aqueous solvent.

14. The water-soluble unit dose article according to claim 1, wherein the non-aqueous solvent is selected from the group consisting of 1,2-propanediol, glycerol, sorbitol, dipropylene glycol, tripropyleneglycol, polypropylene glycol, and a mixture thereof.

15. The water-soluble unit dose article according to claim 1, comprising 15% or less by weight of the unit dose article of water.

16. The water-soluble unit dose article according to claim 1, wherein the water-soluble film is a polymeric film.

17. The water-soluble unit dose article according to claim 1, further comprising a polymer selected from amphiphilic graft copolymers, carboxymethyl cellulose, modified carboxymethylcellulose, polyester terephthalate polymers, hydroxyethylecellulose, modified hydroxyethylcellulose, or a mixture thereof.

18. The water-soluble unit dose article according to claim 1, comprising at least two compartments, wherein the laundry detergent composition is comprised within at least one compartment.

19. The water-soluble unit dose article according to claim 1, wherein the water-soluble film comprises a blend of polyvinylalcohol polymers and/or polyvinylalcohol copolymers.

20. A process for washing fabrics comprising the steps of:
a. combining a water-soluble unit dose article according to claim 1 with sufficient water to dissolve the water-soluble film and dilute the laundry detergent composition by a factor of between 300- and 800-fold to form a wash liquor;
b. combining the wash liquor with at least one fabric to be washed.
